(19) United States
(12) Patent Application Publication
(10) Pub. No.: US 2013/0315392 A1
(43) Pub. Date: Nov. 28, 2013

(54) METHOD FOR DISPLAYING READABLE CONTENTS ON A MOBILE READING DEVICE IN A LOCATION-RESTRICTED MANNER

(71) Applicant: Andreas Steinhauser, Berlin (DE)

(72) Inventor: Andreas Steinhauser, Berlin (DE)

(73) Assignee: TXTR GmbH, Berlin (DE)

(21) Appl. No.: 13/991,225

(22) PCT Filed: Dec. 6, 2011
(86) PCT No.: PCT/IB2011/002940

§ 371 Date: Aug. 13, 2013

(30) Foreign Application Priority Data
Dec. 3, 2010 (DE) 10 2010 053 651.2

(51) Int. Cl. H04L 29/06

(52) U.S. Cl. CPC H04L 63/0492
USPC 380/258

(57) ABSTRACT

The invention relates to a system and method, by means of which the availability of readable contents (books, magazines, documents) can be linked according to location. The invention further relates to an electronic terminal, in particular a mobile reading device, having means for carrying out said method, and to the use of such an electronic terminal.

The present invention relates to a system and method, by means of which the availability of readable contents (books, magazines, documents) can be limited according to location. The invention further relates to an electronic terminal, in particular a mobile reading device, having means for carrying out said method, and to the use of such an electronic terminal. The priority of the German application No. 102010053651.2 is claimed.

Mobile reading devices, so-called “e-readers” are on the market since some time. Portable computers and mobile phones, so-called “smart phones” can also be used as mobile reading devices. Mobile reading devices are characterized in that they offer the possibility of displaying books, magazines and other written documents in a digital form on a display screen, and thus make them readable, with up to several hundred documents being able to be stored on a mobile reading device. The documents can either be transmitted via a single physical interface (e.g. USB) to the reading device or can be obtained wirelessly via mobile telephony or WiFi. Readable contents are accessible either in an unlimited manner or after payment and after receipt are available on the device without any further restriction. This allows a user, for example, to upload one or more documents, such as complete books, on his or her mobile reading device and read them at any location.

According to prior art, methods are known, by means of which readable contents are transmitted at specific locations to a reading device. The published patent application [1] describes a mobile device which is capable to identify its location and, where available, to receive location-related contents. The device can determine whether the location has already been traced, and the contents have already been received, in order to avoid retransmission. This ensures that the user of such a device receives only new or up-to-date contents. Another publication [2] describes the use of such a technology in a museum, where information about an exhibit is received nearby on a reading device and displayed via a web browser, and can be accessed even after leaving the museum. To establish the location, different technologies can be used. For example, the reading device may receive a radio signal (RFID [3], WiFi [4]), or its position may be determined by GPS [1].

The applications listed above do not take into account, however, what happens with the location-related contents, when the location is left. In the above cases, the contents remain on the reading device and can be viewed at a later time in other locations, too.

However, there are many applications, in which emphasis is placed on that readable contents are made available to the reader only as long as he or she is in a particular area or at a certain location. After leaving this location or area, these contents should not be accessible for the reader anymore. Hereby, it is intended to limit the availability of, for example, security-relevant, licensed or copyrighted contents.

Examples of the need for such solutions are confidential or security-relevant contents. For example, a government agency could want to provide their employees with such reading devices that make documents readable in the offices of government agencies, but which do not show the contents after accidental or intentional removal from the premises.

For larger meetings or conferences, too, there may be cases in which confidential documents (e.g. presentations and/or additional documents) are transmitted to a mobile reading device. If the transmitted contents has a confidential or security-relevant nature (or is protected by copyright), the contents are to be deleted upon leaving the meeting rooms. A system, which simultaneously ensures the readability of many documents by one or more users, while preserving the confidentiality by deleting the documents, once a certain location is left, could provide significant benefits for the use.

It is an object of the invention described herein to ensure that location-related contents that can be displayed on a mobile reading device, are no longer available, as soon as the reading device leaves the respective location.

Prior art does not disclose any solutions therefor.

There is therefore a need of a system and a method for displaying readable contents on a mobile display in a location-restricted manner, by means of which the disadvantages of prior art can be overcome. The solution of this object is achieved by the features characterized in the patent claims, in particular by the method according to claim 1. Further improvements of this basic idea are characterized by the sub-claims.

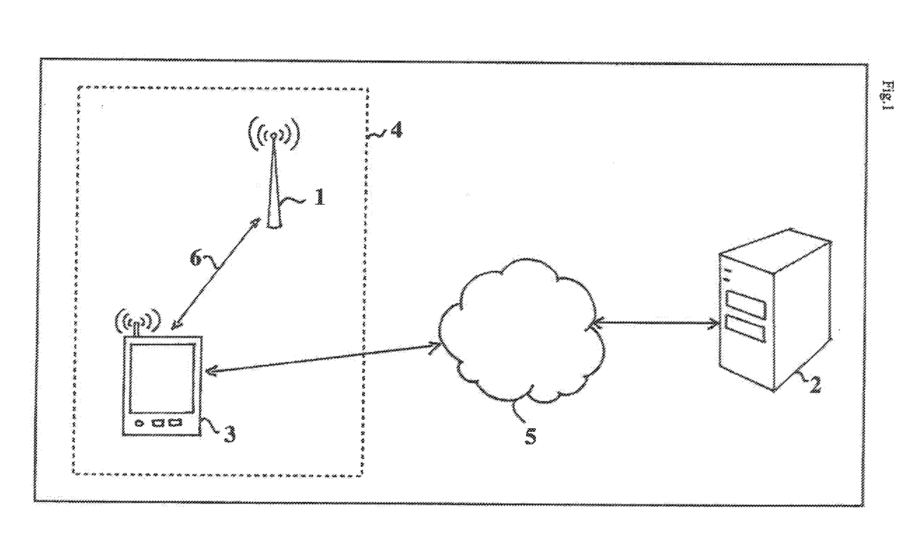

FIG. 1 illustrates the basic configuration of the system infrastructure.

According to the invention, a system for displaying readable contents on a mobile display in a location-restricted manner includes:

a) at least one object locator (1), characterized in that it emits a signal, which identifies it in a unique manner. For carrying out the method according to the invention, the object locator may further include a receiver unit for radio signals and a data processing unit.

b) at least one server (2), characterized in that therein are stored all necessary data for carrying out the method. These data include the contents to be available in a location-restricted manner, and guidelines, values and algorithms for use of authentication and encryption methods, which are necessary for the method according to the invention. Furthermore, the server has a (wireless or wired) connection to a communication network (5).

c) at least one portable reading device (3), which can represent the location-restricted readable digital contents on a display. The reading device includes a data processing unit, as well as at least one transmitter and receiver unit and a connection to a communication network, in order to be able to communicate with the object locator and server for carrying out method presented here (6, 5).

The system according to the invention is characterized in that the object locator (1) is disposed at the location or in the area (4), where contents readable in a location-restricted manner should be made available. The readable contents available in a location-restricted manner are stored on a server (2) and can be displayed on a portable reading device (3).

The contents available in a location-restricted manner are to be transmitted in an encrypted form from the server to the reading device and can only be decrypted using a signal on the reading device received from the object locator.

A central element of the system according to the invention is the so-called object locator (1) that identifies in a unique manner the area or location (4) where it is. In a preferred embodiment, the object locator (1) is a short-range radio (e.g., RFID, Bluetooth) transmitter and receiver unit. The range of the radio signal can be determined according to the size of the area or the location (4), where contents readable in a location-restricted manner are to be made available, and may for example be a few centimeters or several meters. It is crucial that the object locator transmits a signal (ID) (6), which can be received by the mobile reading device (3) and identifies the object locator in a unique manner. This can be implemented by that the object locator transmits a signal at regular time intervals. It is also conceivable that the object locator emits a signal exactly then when it has previously received a signal from a mobile reading device. Equally, light signals, barcodes or sound signals are suitable that can be received and processed by a portable reading device (6). Further, the object locator is capable to receive signals from a portable reading device (6) and further process them, for example as part of an authentication process.

For particularly security-sensitive areas, of course, a combination of several object locators can be selected. Furthermore, it is possible that the ID emitted by the object locator changes at regular or irregular intervals.

Information about locations or areas (4) equipped with object locators (1), the contents available in a location-restricted manner at these locations or areas, and guidelines and values for carrying out the method according to the invention are stored on at least one server (2). The server manages the contents readable in a location-restricted manner. Therein are registered and stored the identities of the object locators and, if applicable, any information about the locations, where there are object locators, and the respectively contents available at these locations. Furthermore, the server comprises the means to encrypt the contents and to initiate an authentication process between mobile reading device and object locator. Further, the server is connected via the communication network (5) to the mobile reading device. Readable contents are stored on the server in an electronic form in the respective file formats (including epub, pdf, txt). In dependence on the identity of the object locator, the contents can be encrypted by the server in a specific method. Encryption methods, digital signatures or certificates that can be used for this purpose are known in the art. A decryption key can then be generated on the reading device for example from the signal transmitted by the object locator, in order to be able to open and view the contents. This key may also be, same as the signal emitted from the object locator, time-dependent and variable.

In one possible embodiment of the system according to the invention, the server and the object locator may be integrated in one device.

In another embodiment of the system according to the invention, the server and the object locator are constituents of a mobile unit, which for example persons can carry with them, so that access to readable contents is possibly only in the vicinity of such persons.

The reader or user operates a mobile reading device (3) using the means for carrying out the method according to the invention. The mobile reading device comprises a display for displaying readable contents. Furthermore, it comprises at least one energy storage device, such as battery, data reception, data processing and data transmission units, which are necessary to implement the method according to the invention. The mobile reading device (3) is wireless, e.g. connected to the server via WiFi or mobile telephony (5). It comprises a receiver unit (such as an antenna, photo sensor, microphone), by means of which the signals (6) outgoing from the object locator (1) can be received. Furthermore, it comprises a transmitter unit to send signals to the object locator (6) for carrying out the method described herein.

Further, the mobile reading device comprises at least one unit for deleting the data. Preferably, the data on the reading device will be completely and irreproducibly deleted, if access is to be made no longer possible. In less security-relevant applications, it is also possible that the data are not actually deleted, but remain in an encrypted form in the data memory of the mobile reading device, however in absence of an object locator there is no signal for decrypting available and therefore the contents cannot be shown on the display. The advantage of this less secure embodiment is that at re-entry into a predetermined area, no re-transmission of data needs to take place, but the data need only be decrypted again in order to be displayed.

Access to the reading device can additionally be secured, for example by a PIN entry of the user. It may also have a unique device identifier (e.g. serial number, IP address or number of an integrated SIM card), by which also the owner of a reading device can be identified. As a result, the method presented here is also capable to restrict the availability of location-restricted contents to certain reading devices, and thus to certain users.

In order to further increase the security of the system, the reading device may also be equipped with GPS. The location of the reading device can then additionally or alternatively be validated for the object locator by using its GPS signal.

The basic principle of the method according to claim 1 by means of the infrastructure described is that the mobile reading device (3) when approaching an object locator (1) receives a unique identifier (4) therefrom that it transmits to the server (2). The server determines the contents that are available at this location in a restricted manner. Depending on the object locator, the contents are encrypted using a predetermined method. By means of a signal transmitted by the object locator, the contents being present in an encrypted form can be decrypted on the reading device. Outside the range of the object locator (1), these contents remain encrypted and then are no longer readable on the mobile reading device (2).

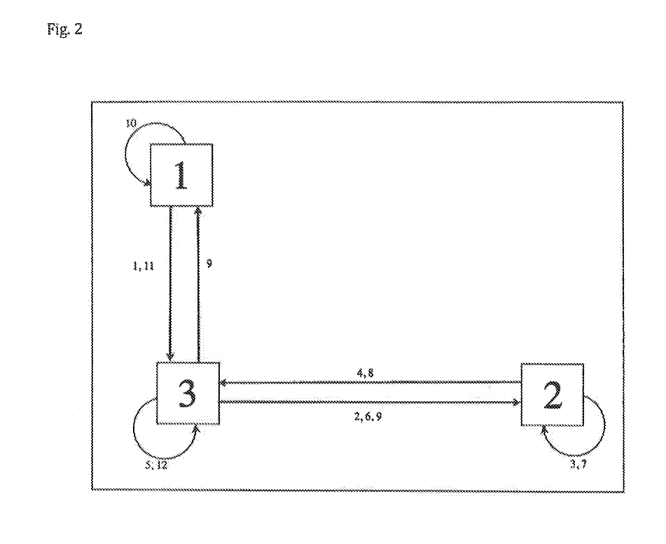

An exemplary embodiment of the whole system and of the method of operation is shown in FIG. 2. Based on the infrastructure comprising an object locator (1), a server (2) and a portable reading device (3), the individual possible process steps in FIG. 2 are described.
1: In the preferred embodiment, the object locator is a short-range radio (e.g., Bluetooth, RFID) transmitter and receiver unit. The object locator present in the area transmits a periodic short-range radio signal comprising a flag (code number, ID) that identifies it in a unique manner. The range of the transmitted signal is adjusted to the size of the area. It is also conceivable that the object locator only transmits its identifier, after it receives a signal from a mobile reading device.

The mobile reading device receives the signal emitted by the object locator. In a preferred configuration of the reading device, the receiver unit is continuously active. It is conceivable that the device turns on when a radio signal is received, should it have been switched off or in standby before.
2: The mobile reading device transmits the received ID to the server and sends at the same time a request for the contents available under this ID. In this step, in addition, an identification of the reading device can be transmitted, based on which it can be found out whether the reading device, that is, its user is entitled to receive the contents.
3: The server determines by means of the received object locator ID the contents available in a restricted manner stored under this ID. When there are settings for restricted user permission, the identity of the reading device is checked, and it is determined whether it is authorized to receive the contents.
4: The server transmits a survey of the available contents, for example in the form of a list of document titles, to the mobile reading device.
5: In a preferred embodiment, there is shown in the menu of the device that readable contents are available at the location of the object locator. This is signaled either by a character (icon) next to an existing menu item or by the appearance of an additional menu item on the display of the reading device.
6: The user of the mobile reading device decides, whether and to which of the contents offered he or she wishes access. He or she chooses, for example, a title in the menu of reading device, and requests thus for the release of these contents to the server.
7: The server encrypts the contents requested by a method predetermined for this object locator.
8: The encrypted contents are transmitted to the reading device. At the same time, a request for authentication for the object locator is sent to the reading device. Thus, it can be ensured that the reading device actually is within the range of the object locator and no fake ID was transmitted. In a preferred embodiment, this is realized by means of a challenge-response method known in the art. Conceivable here are however also other known authentication methods (e.g., one-time password, TAN), which should be selected according to the criticality.
9: The request for authentication is forwarded from the reading device to the object locator.
10: In the data processing unit of the object locator, the response to the authentication prompt is generated according to the predetermined method.
11: The response is transmitted by the object locator in the form of a radio signal to the reading device.
12: With successful authentication, the requested contents can be decrypted by means of the response signal transmitted by the object locator. The selected document can then be opened and read.
The contents are available in units (for example, pages or chapters). That is, with the first successful authentication following the request of a document, the first page or the first chapter is decrypted. When turning over or when a different (the next) chapter is selected, the steps 6-11 are performed again. If authentication is successful again, the next page or chapter is transmitted, decrypted and opened.
It is also possible to set a certain period of time, within which the transmitted and decrypted contents can be accessed, before they are re-encrypted, and re-authentication is required.
If authentication fails, no new contents are sent to the reading device, or contents already transmitted cannot be decrypted. This is for example the case, when the reading device is not in range of the object locator, i.e. does not receive signals from it. Already received contents cannot be opened again, as in the absence of an object locator no key for decrypting the contents can be generated. Access to the contents will be denied, or the contents are deleted.

In less security-critical applications, the authentication method (steps 8-11) may be omitted. Contents available in a location-related manner are then transmitted to the reading device, immediately after sending the object locator ID from the reading device to the server, and can directly be decrypted and displayed using the signal emitted by the object locator. The contents are then available as long as a signal is received from the object locator. If no signal is received anymore from the object locator, the contents remain encrypted, and thus access to the contents is blocked.

In order to increase the security of the system, several object locators can also be disposed at one location. Contents available in a restricted manner can then only be received, if a valid signal is received from all object locators. Different technologies may be combined, such as light signals and radio signals. Additionally or alternatively, a GPS signal emitted by the reading device can also be used for an accurate determination and validation of the location.

In an embodiment of the method, when there is no signal received anymore from the object locator, the survey of the contents may remain in the menu of the reading device, the documents cannot be opened, however, because upon a corresponding request authentication will fail, and no key to open the documents can be generated, as indicated for example by a character (icon) in the menu. In this case, it is left to the user of the reading device to clear himself or herself the list or the menu items.

In a preferred embodiment, the contents are, in the event that authentication fails, completely deleted from the data memory of the reading device, and also the menu item or the list of the contents available in a location-restricted manner are deleted, as soon as authentication fails and the contents cannot be decrypted. A highly secure method for deleting data is multiple overwriting.

Furthermore, the deletion of the contents, of the list, or of the menu item can only be made in the device, if authentication should repeatedly fail after a certain number of attempts or after a certain time.

Likewise, a time can be determined, after which the location-restricted contents are re-encrypted or deleted from the data memory of the reading device.

An application scenario for the system according to the invention is described below:

A company or agency provides information for employees on a server. The company or the agency further defines the locations or areas, at which employees should have access to the information provided, such as offices, conference rooms, or even the whole building, with or without outdoor facilities. For this purpose, at such locations or in these areas, object locators are disposed that, for example, emit a radio signal with a limited range. The identity of each disposed object locator is uniquely encoded in this radio signal and is stored on the server, where it is provided with a reference to contents available in a restricted manner at the location marked by the object locator.

A user (employee of the company or agency or otherwise authorized) of the system is equipped with a mobile reading device. In one possible embodiment of the mobile reading device, the user must first identify, for example by entering a numerical code, fingerprint, iris scan, etc. Transmitter and receiver units, which are used to communicate with object locators and server, are then activated.

When the mobile reading device gets within the range of an object locator, it receives the radio signal thereof and thus its ID. The reading device will forward this identification, for example, by mobile telephony or WiFi to the server. The server determines the information and contents associated with this ID and sends a survey of contents available in a location-restricted manner to the reading device. In the menu of the reading device, the user can see that contents in a location-restricted manner are available and can be selected. At this time, only this survey is displayed, the contents themselves are not yet available.

The user selects a document from the list and confirms his or her selection, for example, by pressing a button or touching the screen. The server receives the request to release the selected document, whereupon it encrypts the requested contents using a predetermined method and initiates a defined authentication process between the reading device and the object locator. This is to ensure that a mobile reading device is actually within the range of a particular object locator and no fake ID has been sent to the server. This authentication method may be any type of authentication that is known in prior art, and must be selected according to its security requirements by the government agency or company. In a preferred embodiment, this is realized by means of a challenge-response method. That is, the server sends a challenge via the reading device to the object locator, which in turn generates a response and sends it to the reading device. But other known authentication methods (e.g., one-time password, TAN) can also be used, these should be chosen according to the criticality. Similarly, the type of encryption can be set accordingly. The guidelines and values for carrying out the authentication are therefore only known to the server and the object locators.

Upon successful authentication, the selected contents on the reading device to be decrypted. Contents are transferred in units (e.g. pages or chapters). That means the user can first open the first page or the first chapter of the requested document. Turning over or the selection of the next chapter is connected to the re-sending of a request to the server, which in turn performs the encryption and initiates authentication.

Authentication can in addition be connected to the identity of the user or of the reading device, so that the contents available in a location-restricted manner can be bound to certain persons or groups of persons.

When the user leaves the predetermined area or is not at the location indicated by the ID object locator, then the reading device will not receive any signals from the latter. In this case, the reading device will not receive a valid response for the authentication method and loses access to pages of the document already open and to other pages. The survey of the contents available in a location-restricted manner and the contents themselves are deleted from the memory of the reading device. Here, it is conceivable to provide a time delay between the signal loss and the deletion of the contents, in order to prevent that contents will be deleted in the case of short-term signal interferences.

In an alternative embodiment, the object locator may also serve as a light source, such as an infrared lamp. The radiated signal would then be detected by means of an appropriate sensor in the portable reading device. Other possibilities are 2D or 3D barcodes, which can be detected by the reading device by means of corresponding image-processing technologies. Another alternative would be an object locator, which emits an ultrasonic signal, which is detected by a corresponding microphone in the portable reading device.

In especially security-sensitive areas, a combination of several object locators can also be applied. For example, a light signal with a limited range could be used as a first object locator, which is verified by a second object locator, such as a radio signal.

Other possible applications for the system presented here are for example in libraries and bookstores. Thus, within a library building, documents including book contents can be made available. The library user can search and read, using the system according to the invention, the desired books within the library by means of a portable reading device, as long as he or she is in the library's premises. The ID of the object locators can be linked, for example, on the server with the appropriate department and the related book titles that are held there. When the user leaves the library building again, access to the contents will be deleted, so there do not occur any copyright infringements. Corresponding configurations can be used for bookstores, where the user gets access to extracts, which are deleted when the user leaves the premises of the book-store again. If the user wishes to buy a book, this can be done in the traditional manner, or a book in digital form can be purchased.

Another application of the system according to the invention may be that in a waiting room, for example, in a train station, an airport lounge, or doctor's office, magazines, books and brochures are made available to location-restricted display.

### Literature References:

[1] US 2010/0190513A1

[2] M. Spasojevic, Kindberg T.: A Study of an Augmented Museum Experience. HP techreport. Jul. 19, 2001

[3] J. Schwieren, Vossen, G.: Implementing Physical Hyper-links for Mobile Applications using RFID tags. IDEAS 2007. September 2007.

[4] Surminen J. M. et al: Location-based DRM using WiFi access points. ISCIT Symposium 7, Oct. 2007.

1. A method for displaying readable contents on a mobile display in a location-restricted manner, characterized by the following steps:
An object locator emits a signal that identifies it in a unique manner and which is received by the reading device, as soon as it is in the range thereof.
The reading device transmits the received identity of the object locator to a server and simultaneously sends a request for the contents available under this ID to the server.
By using the object locator ID, the server determines the contents available in a location-restricted manner stored under this ID.
The server encrypts the contents using a method predetermined for the object locator.
The server sends the encrypted contents to the reading device. At the same time, a request for authentication for the object locator is sent to the reading device.
The request for authentication is forwarded from the reading device to the object locator.
The object locator sends the response to the request for authentication to the reading device.
By means of the response from the object locator, the contents can be decrypted and opened on the reading device.

2. The method for displaying contents readable in a location-restricted manner on a mobile reading device according to claim 1, characterized in that the object locator transmits a signal identifying it in a unique manner only if it has previously received a signal of the reading device.

3. The method for displaying contents readable in a location-restricted manner on a mobile reading device according to claim 1, characterized in that the signal emitted by the object locator can be variable.

4. The method for displaying contents readable in a location-restricted manner on a mobile reading device according to claim 1, characterized in that the server after receiving the object locator ID first sends a survey of the contents available in a restricted manner to the reading device, from which the user of the reading device can choose, which contents are to be transmitted from the server to the reading device.

5. The method for displaying contents readable in a location-restricted manner on a mobile reading device according to claim 1, characterized in that the contents available in a location-restricted manner are transferred in units from the server to the reading device, and that the process of authentication is required again, when another unit is selected.

6. The method for displaying contents readable in a location-restricted manner on a mobile reading device according to claim 1, further characterized in that the contents available in a location-restricted manner are displayed for a certain time on the reading device, before another re-authentication of the object locator is required.

7. The method for displaying contents readable in a location-restricted manner on a mobile reading device according to claim 1, characterized in that, when no signal is received from the object locator anymore, the contents are deleted from the memory of the reading device.

8. The method for displaying contents readable in a location-restricted manner on a mobile reading device according to claim 1, characterized in that, when no signal is received from the object locator anymore, the contents are kept in an encrypted form in the memory of the reading device.

9. The method for displaying contents readable in a location-restricted manner on a mobile reading device according to claim 1, characterized in that the receipt of location-restricted contents is bound to a user authorization, the user being identified by a device identification of the mobile reading device.

10. A use of a system consisting of one or more object locators, servers and mobile reading devices, for carrying out the method for displaying contents readable in a location-restricted manner on a mobile reading device according to claim 1.

11. A use of a system consisting of one or more object locators, servers and mobile reading devices, wherein said servers and object locators are integrated in a device, for carrying out the method for displaying contents readable in a location-restricted manner on a mobile reading device according to claim 1.
